(19) United States
(12) Patent Application Publication
(10) Pub. No.: US 2002/0122393 A1
(43) Pub. Date: Sep. 5, 2002

(54) Antenna diversity in a wireless local area network

(75) Inventors: Richard J. Caldwell, Redhill (GB); David H. Evans, Crawley (GB); Robert Fifield, Rephill (GB)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/067,282

(22) Filed: Feb. 4, 2002

(30) Foreign Application Priority Data
Mar. 1, 2001 (GB) 0105019.4

(51) Int. Cl. H04Q 7/00

(52) U.S. Cl. 370/328; 370/338

(57) ABSTRACT

A method whereby a mobile terminal (MT) operating in a wireless local area network (WLAN), for example HiperLAN2, can effect antenna diversity. The mobile terminal which has at least two antennas (24, 26) monitors downlink fields in successive time frames in a time division radio transmission for indications of when downlink message signals are to be sent to mobile terminals other than the one effecting the monitoring and determines from the indications when there will be in the time frame a time period of sufficient duration for the mobile terminal to effect antenna diversity measurements. The mobile terminal measures in the selected time period the quality of signal reception by each of the at least two antennas and selects the one of the said at least two antennas providing the better (or best) quality of signal reception.

The present invention relates to selecting an antenna in an antenna diversity system.

The present invention has particular, but not exclusive, application to practising antenna diversity in a Wireless Local Area Network (WLAN) such as HiperLAN2 which for convenience of description will be referred to in the following discussion.

A HiperLAN2 network is a broadband radio transmission protocol which can offer bandwidths ranging from between 1 Mbit/s and 11 Mbit/s. It can be applied to domestic as well as office environments. The architecture comprises a fixed local area network consisting of Access Points (AP) and Mobile Terminals (MT) which communicate with the APs over an air interface. HiperLAN2 also has provision for direct communication between two MTs. The user of an MT may move around freely in the HiperLAN2 network, which will ensure that the user and the MT get the best possible performance. In order to improve system performance it has been proposed that the MTs have at least 2 antennas and practice antenna diversity.

In operation the Medium Access Control (MAC) protocol used is based on a dynamic time-division multiplication access and a time—division duplex air interface in which a time slotted structure, termed MAC frames, is used. Each MAC frame commences with a preamble and preamble sequences have been designed which allow antenna selection to be executed before the main data packet is received. A drawback to relying on such preamble sequences is that this method of antenna selection is time critical and relies upon fast switching and fast settling times in order to achieve any meaningful measurements of antenna selection. The duration over which the antenna selection can be made is also small which will also limit the certainty of any measurements taken.

WO99/34535 discloses an antenna diversity switching system for TDMA—based telephones in which signal quality is measured and the antenna having the clearest signal quality is measured. The selection method can be carried out in two phases. In a first phase, signal quality is measured in a real time mode by for example monitoring preamble. In a second phase signal quality is measured after the signals have been received, for example by checking CRCs.

As mentioned earlier, a method based on preamble measurement alone is not reliable and the added time overhead of non-real time measurement by checking CRCs means that there is an implicit delay in selecting the best (or better) antenna.

An object of the present invention is to provide a reliable and fast method of antenna selection in a WLAN such as HiperLAN2.

According to a first aspect of the present invention there is provided a method of selecting an antenna in an antenna diversity system, comprising a station having at least two antennas making received signal quality measurements for at least one of said at least two antennas during at least a portion of a time division time frame in which downlink signals are addressed specifically to another station and selecting one of the said at least two antennas providing the best (or better) quality of signal reception for use.

According to a second aspect of the present invention there is provided a wireless local area network comprising a primary station having transceiving means for transmitting signals on downlink and receiving signals on an uplink and at least one secondary station having transceiving means for receiving downlink signals and for transmitting uplink signals, the downlink and uplink signals being transmitted in accordance with a time division protocol comprising successive time frames, the at least one secondary station having at least two antennas and means for selecting one of said at least two antennas in response to antenna diversity measurements made during at least a portion of a time division time frame in which downlink signals are not addressed specifically to the secondary station.

According to a third aspect of the present invention there is provided a secondary station for use in a wireless local area network comprising a primary station having transceiving means for transmitting signals on a downlink and receiving signals on an uplink, the secondary station including transceiving means for receiving downlink signals from the primary station and for transmitting uplink signals, the downlink and uplink signals being transmitted in accordance with a time division protocol comprising successive time frames, the secondary station further comprising at least two antennas and means for selecting one of said at least two antennas in response to antenna diversity measurements made during at least a portion of a time division time frame in which downlink signals are not addressed specifically to the secondary station.

The time period in which antenna diversity measurements are made may correspond to the duration of at least one data packet. The monitoring for the occurrence of the said indications may be done in successive time frames or alternatively the frequency of monitoring may be varied to suit changes occurring in the radio channel. For example if rapidly occurring changes are occurring due say to the movement of the station relative to an access point, the frequency of monitoring is increased but in a converse situation the frequency of monitoring may be reduced to an arbitrarily set minimum.

If signal quality measurements for one of the at least two antennas are made when downlink signals are specifically addressed to the secondary station, then the time required to effect signal measurements by all the antennas is reduced.

The present invention will now be described, by way of example, with reference to the accompanying drawings, wherein:

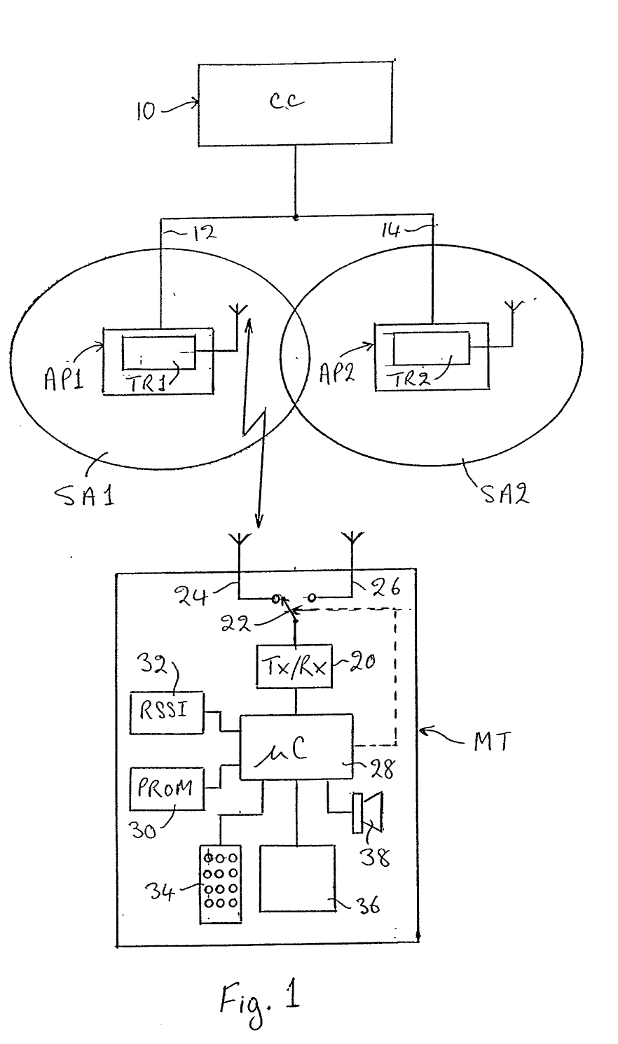

FIG. 1 is a block schematic diagram of a HiperLAN2 system,

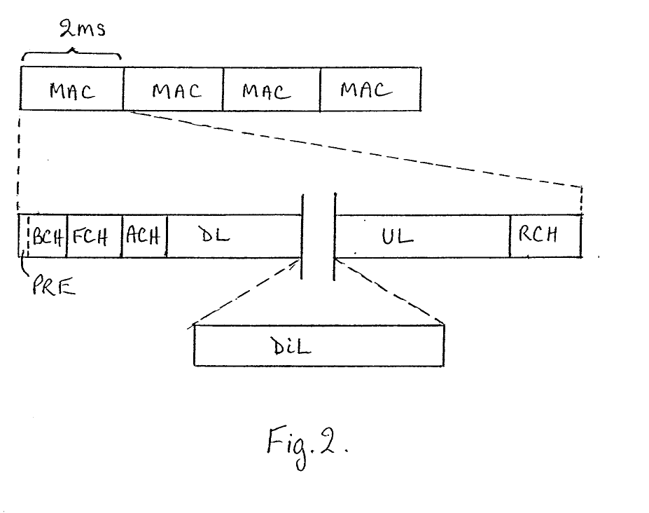

FIG. 2 illustrates a basic MAC (Medium Access Control) layer of a single sector HiperLAN2 system, and

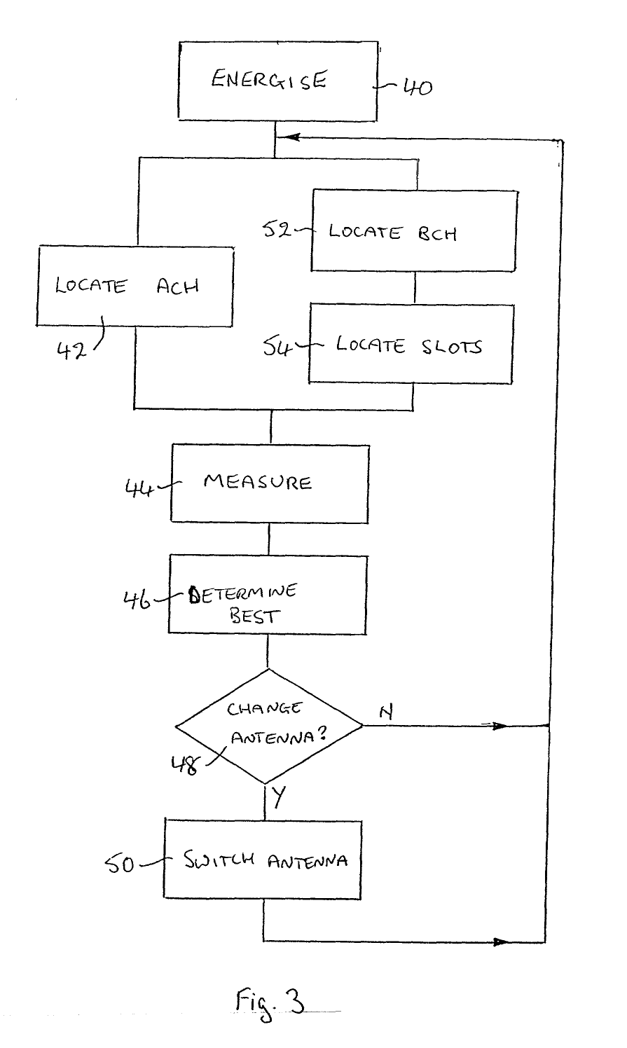

FIG. 3 is a flow chart relating to the making of diversity measurements and selecting an antenna.

In the drawings the same reference numerals have been used to indicate corresponding features.

Referring to FIG. 1, the illustrated HiperLAN2 system comprises a central controller (CC) 10 which is connected by conductive paths 12, 14 to respective Access Points (AP) AP1, AP2. Each of the APs AP1, AP2 comprises a radio transceiver TR1, TR2 which defines an air interface or service area SA1 SA2, respectively. A plurality of mobile terminals MT, only one of which is shown, are able to roam in the service areas SA1, SA2 associated with the CC10 and maintain radio contact over a HiperLAN2 air interface.

In the illustrated embodiment of the MT a transceiver 20 is coupled by way of a diversity switch 22 to one of two antennas 24, 26. The MT is controlled by a microcontroller 28 in accordance with software stored in a PROM 30. A Radio Signal Strength Indicating (RSSI) stage 32 is coupled to the microcontroller 28 for measurement of the signal strength of the signal received at each of the antennas 24, 26 in response to actuation of the switch 22 by control signals generated by the microcontroller 28.

The MT may be any suitable apparatus, such as a lap-top computer or portable television receiver, which is equipped with a keypad 34, a viewing screen 36 and a loudspeaker 38.

In operation control is effected through the APs AP1, AP2 which inform the MTs in their respective service areas at which point in the MAC frame, to be described with reference to FIG. 2, they are allowed to transmit their data.

The HiperLAN2 interface is based on time-division duplex (TDD) and dynamic time—division multiple access (TDMA). This time slotted structure of the medium allows for simultaneous communication in both downlink and uplink within the same time frame, called MAC frame in HiperLAN2.

Referring to FIG. 2, time slots for downlink and uplink communication are allocated dynamically depending on the need for transmission resources. The basic MAC frame structure on the air interface has a fixed duration of 2 ms and comprises transport channels for broadcast control BCH, frame control FCH, access control ACH, downlink DL, uplink UL and random access RCH. Provision is made for direct MT to MT communication in a DiL phase located between downlink DL and uplink UL. All data from both AP and MTs is transmitted in dedicated time slots, except for the random access channel RCH where contention for the same slot is allowed. The duration of broadcast control BCH is fixed whereas the duration of other fields is dynamically adapted to the current situation.

The broadcast channel BCH is downlink only and contains control information that is sent in every MAC frame and reaches all the MTs. The BCH provides information (not exhaustive) about transmission power levels, starting point and length of the FCH and the RCH, wake-up indicator, and identifiers for identifying both the HiperLAN2 network and the AP. The broadcast channel begins with a preamble PRE.

The frame control channel FCH is downlink only and contains an exact description of how resources have been allocated (and thus granted) within the current MAC frame in the downlink DL- and uplink UL-phase and for the random access channel RCH.

The access feedback channel ACH is downlink only and conveys information on previous access attempts made in the RCH.

Downlink or uplink traffic DL- and UL-phase is bidirectional and consists of product data unit (PDU) trains to and from MTs. A PDU train comprises data link control DLC user PDUs of 54 bytes with 48 bytes of payload and DLC control PDUs of 9 bytes to be transmitted or received by one MT. There is one PDU train per MT (if resources have been granted in the FCH). The relative position of the transmission of transport and PDU trains are identified by pointers given in the broadcast channel BCH and the frame control channel FCH.

The random access channel RCH is uplink only and is used by the MTs to request transmission resources for the DL- and UL-phase in upcoming MAC frames, and to convey some radio link control signalling messages. When the request for more transmission resources increase from the MTs, the AP will allocate more resources for the random access channel RCH. The random access channel RCH is entirely composed of contention slots which all the MTs associated to the AP compete for. Collisions may occur and the results from random access channel RCH access are reported back to the MTs in the access feedback channel ACH.

In order to implement antenna diversity measurements, the MT has to listen to a received signal using one of the antennas at a time and decide which currently provides the better (or best) quality signal. As mentioned in the preamble of the specification, the preamble PRE in the broadcast channel BCH is of too shorter duration in which to make reliable measurements.

The method in accordance with the present invention avoids this problem by enabling the MTs to make measurements at times in a MAC frame when a MT is not actively participating in a communication on the downlink DL. The MT can determine in advance of the downlink DL whether or not there will be a message addressed to it.

A MT can select different parts of a MAC frame depending on circumstances.

(1) If the MT has not made a random access request in the previous MAC frame, then it would not use any information in the access feedback channel ACH of the current frame and can therefore use this for antenna measurements. A drawback to using the access feedback channel ACH is that the duration of the message is short (9 octets):

(2) Messages in the downlink phase DL are generally long enough to allow measurements to be taken relatively easily. A MT listening to the frame control channel FCH can determine which slots in the downlink phase DL are allocated to it and which are for other MTs. It will therefore be able to make antenna measurements of central controller transmissions during slots allocated to other MTs. In a refinement of this process, the MT making the measurements can choose the longest period allocated to another MT;

(3) Messages transmitted between MTs in the DiL phase may be used. A MT not involved in a transmission will know which MT is transmitting and can therefore make measurements in respect of the transmitting MT.

FIG. 3 is a simplified flow chart relating to methods (1) and (2) above.

Block 40 relates to a MT being energised and synchronised with the MAC framing. For method (1) the flow chart proceeds to block 42 which denotes the MT determining the location of the access feedback channel ACH and block 44 denotes the MT making antenna measurements during the period of ACH. Block 46 relates to the MT determining which of the antennas 24, 26 (FIG. 1) gives the better reception. Block 48 relates to deciding if it is necessary to select the other antenna from the one currently being used. If the answer is no (N), the flow chart reverts back to the commencement of listening for the respective phase in the MNAC frame. If the answer is yes (Y), the flow chart proceeds to the block 50 which denotes switching over of the antennas using the switch 22 (FIG. 1). The flow chart then reverts to listening for the respective phase in the MAC frame.

In the case of using method (2), after the MT has synchronised as denoted in the block 40, the flow chart proceeds to block 52 which relates to the MT determining the location of the frame control channel FCH. Block 54 relates to the MT determining the location of the superfluous slots in the downlink. Block 44 relates to making antenna measurements in the determined slot(s). Thereafter the flow chart proceeds as described previously.

A variant of the method described above makes use of the fact that the MAC frame shown in FIG. 2 commences with a downlink portion consisting of network information, frame information, viz. the frame control channel FCH, and downlink data DL and finishes with an uplink portion in which MTs transmit any uplink data UL and random access requests RCH. The information contained in the frame control channel FCH details how resources are to be allocated, namely, at which time slot each MT should expect to receive data in the downlink DL and at which time slot at which to transmit information on the uplink UL. The number of time slots allocated by the central controller CC to each downlink transmission and each uplink transmission is also provided. Thus a MT listening to the frame information can determine when it should receive/transmit and also when all other MTs should receive/transmit. This information can be used to advantage in expediting signal quality measurements by a MT.

In order to illustrate this better assume that a HiperLAN2 network comprises a central controller CC and two mobile terminals MT(a) and MT(b). Mobile terminal MT(a) wishes to make an antenna selection during the current MAC frame and therefore listens to the frame control channel FCH transmitted by the CC. The FCH includes the following information:

MT(a) expect a downlink transmission at time slot 13 for a duration of 10 time slots;

MT(b) expect a downlink transmission at time slot 23 for a duration of 2 time slots;

MT(a) give an uplink transmission at time slot 25 for a duration 5 time slots; and

MT(b) give an uplink transmission at time slot 30 for a duration 12 time slots.

MT(a) is currently using say antenna 24 (FIG. 1) but wishes to determine if a switch to antenna 26 (FIG. 1) would improve reception.

In order to make this check, MT(a) uses the antenna 24 to receive its downlink transmission commencing at the time slot 13. It then carries out signal quality measurements on the antenna 26 during the transmission of data to MT(b). In order to be able to effect these measurements, MT(a) switches to antenna 26 at time slot 23 and the measurements are made over the next two time slots. The quality of the signal received by the antenna 26 is compared with that received by the antenna 24, for example by looking at the level of confidence of decoding output by a convolutional decoder. If the antenna 26 is found to be superior, then switch 22 (FIG. 1) is actuated to change-over from the antenna 24 to the antenna 26.

The antenna measurements are made over the duration of at least one data packet or product data unit PDU of 54 bytes. As HiperLAN2 has provision for transmission of data at a wide variety of bit rates depending on the modulation mode being used, the antenna measurements will be completed more quickly at a high bit rate as opposed to a lower bit rate.

Typically antenna measurements are made in successive MAC frames. However this may be varied if the MT determines that any variation in the measurements made is slow, it may optionally decide to reduce the frequency of monitoring of the MAC frames. If it is estimated that the channel will be stable for a minimum period, say 50 ms, then another set of measurements may be made after the expiry of this period.

Other methods besides measuring RSSI may be used for determining signal quality for example correlation, bit error rate (BER) or looking at the output of a FFT filter.

Although described above in the context of antenna diversity, the present invention is also applicable to other kinds of diversity, for example code diversity in a system employing CDMA (Code Division Multiple Access) techniques.

In the present specification and claims the word “a” or “an” preceding an element does not exclude the presence of a plurality of such elements. Further, the word “comprising” does not exclude the presence of other elements or steps than those listed.

From reading the present disclosure, other modifications will be apparent to persons skilled in the art. Such modifications may involve other features which are already known in the design, manufacture and use of wireless local area networks and component parts therefor and which may be used instead of or in addition to features already described herein.

1. A method of selecting an antenna in an antenna diversity system, comprising a station having at least two antennas making received signal quality measurements for at least one of said at least two antennas during at least a portion of a time division time frame in which downlink signals are addressed specifically to another station and selecting one of the said at least two antennas providing the best (or better) quality of signal reception for use.

2. A method as claimed in claim 1, characterised in that the diversity measurements are made over the duration of at least one data packet.

3. A method as claimed in claim 1, characterised in that every time frame is monitored,

4. A method as claimed in claim 1, characterised by assessing the changes occurring in the radio transmission and by altering the frequency of monitoring of the time frames accordingly.

5. A method as claimed in claim 1, characterised in that signal quality measurements for another of said at least two antennas are made when signals are addressed specifically to the station effecting signal monitoring.

6. A wireless local area network comprising a primary station having transceiving means for transmitting signals on downlink and receiving signals on an uplink and at least one secondary station having transceiving means for receiving downlink signals and for transmitting uplink signals, the downlink and uplink signals being transmitted in accordance with a time division protocol comprising successive time frames, the at least one secondary station having at least two antennas and means for selecting one of said at least two antennas in response to antenna diversity measurements made during at least a portion of a time division time frame in which downlink signals are not addressed specifically to the secondary station.

7. A wireless local area network as claimed in claim 6, characterised in that the at least one secondary station has means for determining from indications in the downlink signals when downlink message signals are to be sent to secondary stations other than the one effecting the antenna diversity measurements, means for determining from the indications when there will be in the at least one time frame a time period of sufficient duration for the at least one secondary station to effect signal quality measurements, and means for comparing the quality of signal reception by each of the at least two antennas and for selecting one of the said at least two antennas providing the best (or better) quality of signal reception.

8. A secondary station for use in a wireless local area network comprising a primary station having transceiving means for transmitting signals on a downlink and receiving signals on an uplink, the secondary station including transceiving means for receiving downlink signals from the primary station and for transmitting uplink signals, the downlink and uplink signals being transmitted in accordance with a time division protocol comprising successive time frames, the secondary station further comprising at least two antennas and means for selecting one of said at least two antennas in response to antenna diversity measurements made during at least a portion of a time division time frame in which downlink signals are not addressed specifically to the secondary station.

9. A secondary station as claimed in claim 8, characterised in that there is provided means for determining from indications in the downlink signals when downlink message signals are to be sent to secondary stations other than the one effecting the antenna diversity measurements, means for determining from the indications when there will be in the at least one time frame a time period of sufficient duration for signal quality measurements to be effected, and means for comparing the quality of signal reception by each of the at least two antennas and selecting means for selecting one of the said at least two antennas providing the best (or better) quality of signal reception.
